(19) United States
(12) Patent Application Publication
(10) Pub. No.: US 2009/0101635 A1
(43) Pub. Date: Apr. 23, 2009

(54) COIL UNIT OF INDUCTION HEATING FIXING DEVICE

(75) Inventors: Shuji YOKOYAMA, Shizuoka (JP); Masanori TAKAI, Shizuoka (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/247,084

(22) Filed: Oct. 7, 2008

Related U.S. Application Data
(60) Provisional application No. 60/981,789, filed on Oct. 22, 2007.

(51) Int. Cl. H05B 6/14

(52) U.S. Cl. 219/619

(57) ABSTRACT

In an embodiment of the invention, a plug is connected to an end of a litz wire of an electromagnetic induction coil. In a state where the plug is protruded, the electromagnetic induction coil, an insulating plate, a magnetic core and a coil holder are integrally sealed with a coil mold. A center coil unit, a first and a second side coil units are arranged to be opposite to a heat roller, the plug is inserted in a socket of a power source code or a connection code, and the electromagnetic induction coil can be connected to a power source.

### CROSS-REFERENCE TO RELATED APPLICATION

This application is based upon and claims the benefit of priority from U.S. Provisional Application Ser. No. 60/981,789 filed on Oct. 22, 2007, the entire contents of which are incorporated herein by reference.

### BACKGROUND OF THE INVENTION

1. Field of the Invention

The present invention relates to a coil unit of an induction heating fixing device for induction heating a conductive heat generating member of a heating member of a fixing device mounted in an image forming apparatus such as a copier, a printer, a facsimile, or the like.

2. Description of the Related Art

In a heat-pressing type fixing device used in an image forming apparatus such as an electrophotographic copier or printer, in order to realize speeding up of process speed, there is a fixing device in which a heat roller or a heating belt having a metal conductive layer is heated by an induction heating system. This induction heating fixing device has high response against the temperature change of the heat roller or the like. By this, the temperature of the heat roller or the like can be immediately raised, and the speeding up of the process speed inclusive of a warming-up time can be realized. The induction heating system is the system in which high frequency current is made to flow through a coil to generate an electromagnetic wave, an induced current by the electromagnetic wave is made to flow through, for example, a metal conductive layer of a heat roller, and the metal conductive layer is heated by Joule heat caused by the induced current.

However, in the case where the metal conductive layer with a small heat capacity is used, the heat generation characteristic of the metal conductive layer is greatly influenced according to the magnetic characteristic of the coil. On the other hand, at the time of power supply to the coil, vibration occurs in the coil by high frequency current flowing through the coil. When the coil vibrates, positional relation between the coil and the metal conductive layer is changed, and the magnetic characteristic of the coil is changed. By this, there is a fear that the heat generation characteristic of the metal conductive layer is changed, and the fixing performance is impaired.

Thus, hitherto, there is a coil unit in which a coil, a magnetic core, and a bobbin for positioning are integrally sealed with an insulating mold, the vibration of the coil is prevented, positioning between the coil and the magnetic core is more certainly performed, and insulation from the surrounding area is ensured.

However, in the above coil unit, a conductive wire constituting the coil is drawn out to the outside of the insulating mold in order to connect the coil to a power source. Further, the wire drawn out to the outside of the insulating mold is extended in the periphery of the coil unit, and is connected to the power source. Thus, there is a fear that noise due to magnetic field by the wire in the periphery of the coil unit is generated. Besides, it is necessary that the space for extending the wire is secured in the periphery of the coil unit. Thus, in the case where the heat roller is heated by plural coil units, the space for the wire of a joint portion of adjacent coil units becomes wide, and there is also a fear that the uneven temperature of the heat roller occurs. In particular, in the case where such as the wire is composed of a litz wire made of plural copper wires, when the diameter of the wire becomes large, the space for extending the wire also becomes large.

Then, a coil unit of an induction heating fixing device is desired in which in the coil unit for heating a conductive heat generating member by an induction heating system, it is not necessary to extend a wire of a coil in the periphery of the coil unit, the coil unit is simplified, and an excellent induction heating characteristic can be obtained.

### SUMMARY OF THE INVENTION

An aspect of the invention is to provide a coil unit of an induction heating fixing device in which a wire of a coil to be extended to the outside of the coil unit is eliminated to simplify the coil unit, and induction heating performance is high.

According to an embodiment of the invention, a coil unit of an induction heating fixing device includes a coil including a conductive wire wound plural times and for generating an induced current in a conductive heat generating member, a magnetic core insulated from the coil and provided to be adjacent to the coil, a positioning holder to position the coil and the magnetic core, a conductive terminal connected to an end of the conductive wire, and a fixing body to expose the conductive terminal and to integrate the coil and the magnetic core supported by the positioning holder.

### BRIEF DESCRIPTION OF THE DRAWINGS

FIG. 1 is a schematic structural view showing an image forming apparatus in which a fixing device using a coil unit of an embodiment of the invention is mounted;

FIG. 2 is a schematic structural view showing the fixing device of the embodiment of the invention;

FIG. 3 is a schematic explanatory view showing arrangement of a heat roller and the coil unit of the embodiment of the invention;

FIG. 4 is a distributed perspective view of the coil unit of the embodiment of the invention;

FIG. 5 is a schematic explanatory view showing fusion welding of a litz wire and a plug of the embodiment of the invention;

FIG. 6 is a schematic perspective view showing caulking connection of the litz wire and the plug of the embodiment of the invention and showing a state where they are covered with a clamp; and

FIG. 7 is a schematic perspective view showing caulking connection of the litz wire and the plug of the embodiment of the invention and showing a state where the clamp is caulked.

### DETAILED DESCRIPTION OF THE PREFERRED EMBODIMENT

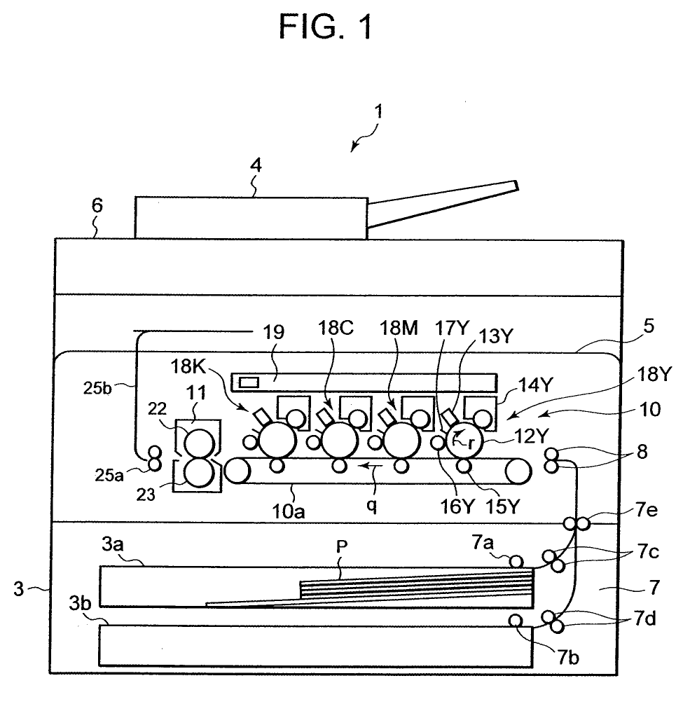

Hereinafter, an embodiment of the invention will be described in detail with reference to the accompanying drawings. FIG. 1 is a schematic structural view showing a four-tandem color copier 1 in which a fixing device 11 as an induction heating fixing device of the embodiment of the invention is mounted. The color copier 1 includes a scanner unit 6 which is disposed on an upper side and is for reading an original document fed by an automatic document feeder 4. The color copier 1 includes an image forming unit 10 having four sets of image forming stations 18Y, 18M, 18C and 18K of yellow (Y), magenta (M), cyan (C) and black (K) arranged in parallel along a transfer belt 10a.

The image forming station 18Y of yellow (Y) includes a charger 13Y, a developing device 14Y, a transfer roller 15Y, a cleaner 16Y, and a charge removal unit 17Y, which are process members and are arranged around a photoconductive drum 12Y as an image carrier to be rotated in an arrow r direction. A laser exposure device 19 for irradiating a laser beam to the photoconductive drum 12Y is provided above the image forming station 18Y of yellow (Y)

The image forming stations 18M, 18C and 18K of the respective colors of magenta (M), cyan (C) and black (K) have the same structure as the image forming station 18Y of yellow (Y).

In the image forming unit 10, when a print operation starts, in the image forming station 18Y of yellow, the photoconductive drum 12Y is rotated in the arrow r direction, and is uniformly charged by the charger 13Y. Next, the photoconductive drum 12Y is irradiated with an exposure light which is generated by the laser exposure device 19 and corresponds to image information read by the scanner unit 6, and an electrostatic latent image is formed. Thereafter, a toner image is formed on the photoconductive drum 12Y by the developing device 14Y, and the toner image is transferred at the position of the transfer roller 15Y to a sheet paper P as a medium to be fixed which is carried in an arrow q direction on the transfer belt 10a. After the transfer is ended, residual toner on the photoconductive drum 12Y is cleaned by the cleaner 16Y, remaining charges on the surface of the photoconductive drum 12Y are removed by the charge removal unit 17Y, and next printing becomes possible.

The sheet paper P is fed from a cassette mechanism 3 including a first and a second paper feed cassettes 3a and 3b to the transfer belt 10a through a carrying path 7. The carrying path 7 includes pickup rollers 7a and 7b for taking out a sheet paper from the paper feed cassettes 3a and 3b, separation carrying rollers 7c and 7d, a carrying roller 7e and a registration roller 8. The fixing device 11 for fixing the toner image formed on the sheet paper P by the image forming unit 10 is provided downstream of the transfer belt 10a. A paper discharge roller 25a is provided downstream of the fixing device 11, and a paper discharge carrying path 25b for carrying the sheet paper P after the fixing to a paper discharge unit 1b is provided.

In the image forming stations 18M, 18C and 18K of the respective colors of magenta (M), cyan (C) and black (K), image formation operations are performed similarly to the image forming station 18Y of yellow (Y), and a full-color toner image is formed on the sheet paper P carried by the transfer belt 10a. Thereafter, the sheet paper P is heated, pressed and fixed by the fixing device 11 as the induction heating fixing device, and is discharged to the paper discharge unit 1b after a print image is completed.

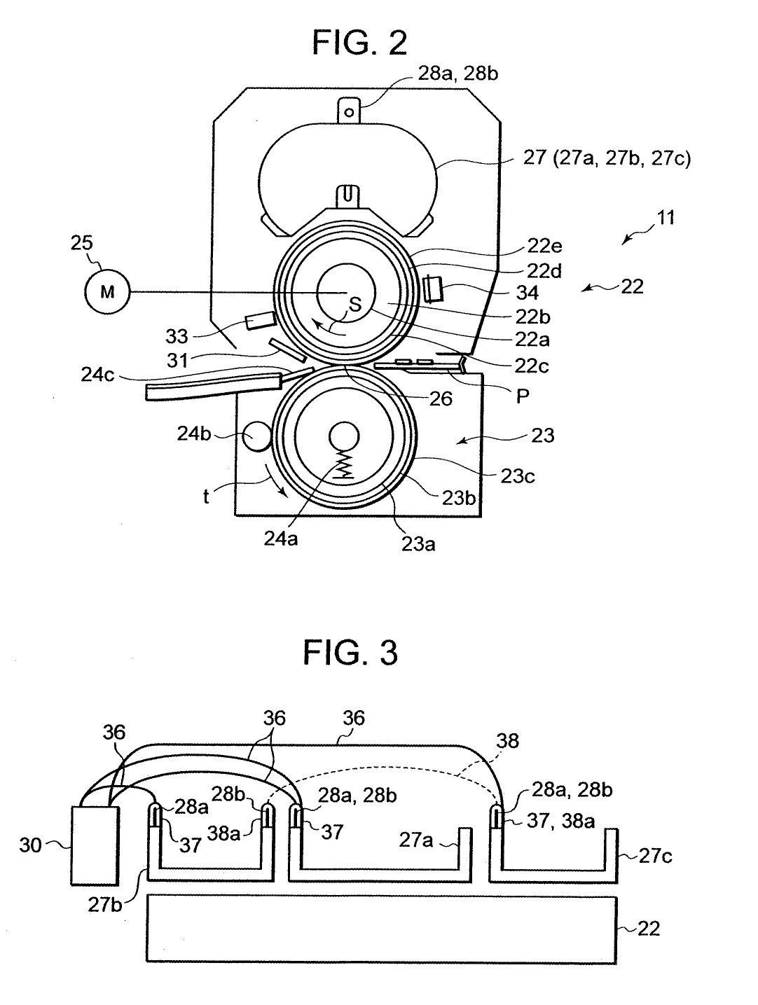

Next, the fixing device 11 will be described. FIG. 2 is a schematic structural view showing the fixing device 11 of an induction heating system. The fixing device 11 includes a heat roller 22 as a heating member and a press roller 23 as a carrying member. The heat roller 22 is rotated in an arrow s direction by a drive motor 25. The press roller 23 is brought into press contact with the heat roller 22 by a pressure spring 24a. By this, a nip 26 with a definite width is formed between the heat roller 22 and the press roller 23. The press roller 23 is driven by the heat roller 22 and is rotated in an arrow t direction.

In the surrounding area of the heat roller 22, a coil unit 27 as an induced current generating coil for heating the heat roller 22 is arranged to be opposite to the heat roller with a gap of, for example, 2.5 mm therebetween. Incidentally, although the gap between the coil unit 27 and the heat roller 22 is not limited, in order to satisfactorily heat the heat roller 22, it is more desirable that the gap is set within the range of 1.5 to 5.0 mm.

Further, a peeling pawl 31 to prevent the sheet paper P after fixing from being wound, a non-contact thermistor 33 to detect the surface temperature of the heat roller 22, and a thermostat 34 to detect the abnormality of the surface temperature of the heat roller 22 and to cut off heat generation are provided around the circumference of the heat roller 22. A press side peeling pawl 24c and a cleaning roller 24b are provided around the circumference of the press roller 23.

Incidentally, in the case where there is no fear that the sheet paper P is wound around the heat roller, the peeling pawl 31, the press side peeling pawl 24c and the like may not be provided. Besides, the number of the non-contact thermistors 33 is arbitrary as required, and a required number of thermistors can be arranged at necessary places in the longitudinal direction of the heat roller 22 as the rotation axis direction of the heat roller 22.

In the heat roller 22, an elastic layer 22b made of an elastic member such as foamed rubber or sponge, a metal conductive layer 22c as a conductive heat generating member made of a conductive member, a solid rubber layer 22d made of heat resistant silicone rubber or the like, and a release layer 22e are formed in sequence around a shaft 22a made of a material having rigidity (hardness) which is not deformed by a specified pressure. The metal conductive layer 22c is formed of a conductive material of nickel (Ni), stainless, aluminum (Al), copper (Cu), composite material of stainless steel and aluminum, or the like. In this embodiment, nickel (Ni) is used.

In the heat roller 22, it is preferable that for example, the thickness of the elastic layer 22b is 5 to 10 mm, the thickness of the metal conductive layer 22c is 10 to 100 μm, and the thickness of the solid rubber layer 22d is 100 to 200 μm. In this embodiment, the elastic layer 22b is 5 mm, the metal conductive layer 22c is 40 μm, the solid rubber layer 22d is 200 μm, and the release layer 22e is 30 μm.

The press roller 23 includes acored bar 23a, a rubber layer 23b of silicone rubber or fluorine rubber provided therearound, and a release layer 23c coated thereon. Both the heat roller 22 and the press roller 23 are formed to have a diameter of, for example, 40 mm. The sheet paper P passes through the nip 26 between the heat roller 22 and the press roller 23 as stated above, so that the toner image on the sheet paper P is heated, pressed and fixed.

Incidentally, the press roller 23 may include a heating mechanism such as a metal conductive layer heated by an electromagnetic induction coil, or a built-in halogen lamp heater as the need arises.

Next, the coil unit 27 will be described. As shown in FIG. 3, the coil unit 27 includes a center coil unit 27a, a first side coil unit 27b, and a second side coil unit 27c. In this embodiment, the first and the second side coil units 27b and 27c are connected in series to each other, and are driven by the same control. For example, the center coil unit 27a has a length of 200 mm, and heats the center area of the heat roller 22.

The first and the second side coil units 27b and 27c are respectively arranged at the sides of the center coil unit 27a. The heat roller 22 having the entire length of 320 mm is heated by the center coil unit 27a and the first and the second side coil units 27b and 27c. The center coil unit 27a and the first and the second side coil units 27b and 27c may be alternately switched and make output, or may simultaneously make output.

A tab-shaped first plug 28a and a tab-shaped second plug 28b as conductive terminals protrude from ends, in the longitudinal direction, of the center coil unit 27a and the first and the second side coil units 27b and 27c on the side not opposite to the heat roller 22. The first and the second plugs 28a and 28b are respectively connected to a starting end 412a and a trailing end 412b of a litz wire described later. The first and the second plugs 28a and 28b are freely attached to and detached from sockets 37 of power source codes 36 as power source supply units connected to a power source 30.

The way of arrangement of the first and the second plugs 28a and 28b in the center coil unit 27a and the first and the second side coil units 27b and 27c is not limited. The arrangement of the first and the second plugs 28a and 28b can be freely set according to the arrangement position of the power source 30, the connection state among the plural coil units 27a, 27b and 27c or the like.

For example, as shown in FIG. 3, in the case where the power source 30 is arranged on the side of the first side coil unit 27b, in the center coil unit 27a, the first and the second plugs 28a and 28b are arranged at the end in the longitudinal direction closer to the power source 30. In the first side coil unit 27b, the first plug 28a is arranged at the end in the longitudinal direction on the power source 30 side, and the second plug 28b is arranged at the end on the opposite side. In the second side coil unit 27c, the first and the second plugs 28a and 28b are arranged at the end in the longitudinal direction on the power source 30 side.

The first and the second plugs 28a and 28b of the center coil unit 27a are inserted in the sockets 37 of the power source codes 36. The first plug 28a of the first side coil unit 27b is inserted in the socket 37 of the power source code 36, and the second plug 28b of the second side coil unit 27c is inserted in the socket 37 of the power source code 36. Further, the second plug 28b of the first side coil unit 27b and the first plug 28a of the second side coil unit 27c are inserted in sockets 38a of a connection code 38, so that the first and the second side coil units 27b and 27c are connected in series to each other. By doing so, the power source code 36 for supplying electric power from the power source 30 and the connection code 38 can be respectively shortened.

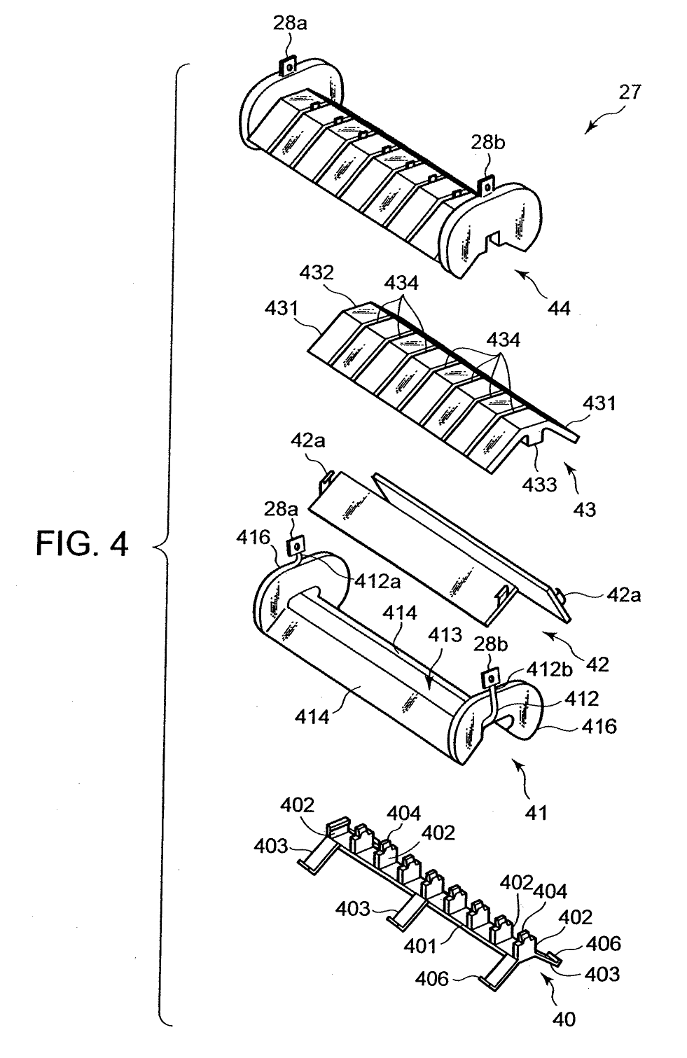

Next, the structure of the coil unit 27 will be described. The center coil unit 27a and the first and the second side coil units 27b and 27c are different from each other in length, and are different in attachment position of the plug 28 as required, however, the inside structure is the same, and therefore, they will be described as the common coil unit 27. As shown in FIG. 4., the coil unit 27 includes a coil holder 40 as a positioning holder, a winding electromagnetic induction coil 41 as a coil, an insulating plate 42 as an insulating body, a magnetic core 43, and a coil mold 44 as a fixing body.

The electromagnetic induction coil 41 is formed by winding a litz wire as a conductive wire plural times. The litz wire is formed by bundling plural copper wires each of which has a diameter of about 0.1 to 0.5 mm and the surface of each of which is coated with heat resistant enamel such as heat resistant polyimidoamide. The electric wire of the conductive wire and the coat material are not limited to this, and the wire diameter is also arbitrary. Besides, when the litz wire is used, the structure thereof is also arbitrary, and it may be formed by twisting plural insulating copper wires, and the number of the copper wires and the thickness are also not limited. By using the litz wire, since current can be made to flow by using the respective surfaces of the copper wires constituting the litz wire, the current flowing through the electromagnetic induction coil can be efficiently used.

The electromagnetic induction coil 41 has a winding form formed by winding one litz wire around an arbitrary thin and long forming stand plural times. When the electromagnetic induction coil 41 is removed from the forming stand after the electromagnetic induction coil 41 is formed, a thin and long coil hole 413 corresponding to the forming stand portion is provided in the electromagnetic induction coil 41. At a coil center part 414 of the electromagnetic induction coil 41, the wire is wound in parallel to the longitudinal direction of the coil hole 413. At a coil end 416 of the electromagnetic induction coil 41 parallel to a short-side direction of the coil hole 413, the wire is wound so as to rise in the vertical direction with respect to the coil center part 414 and has a fan shape.

The starting end 412a and the trailing end 412b of the litz wire, which are the ends of the conductive wire, are respectively fixed to the center portions of the right and left coil ends 416. Incidentally, the starting end 412a and the trailing end 412b of the litz wire may be fixed to either of the right and left coil ends 416 according to the usage of the coil unit 27.

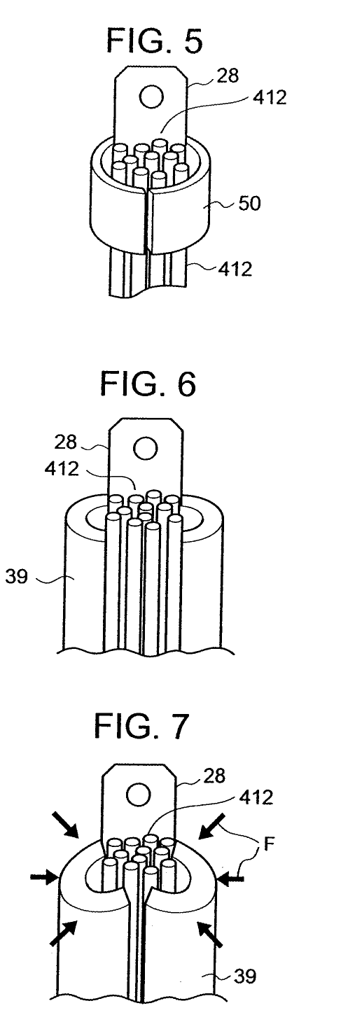

The first plug 28a is connected to the starting end 412a of the litz wire fixed to the coil end 416, and the second plug 28b is connected to the trailing end 412b. Next, connection between the litz wire and the plug will be described. For example, in the case where connection is performed by fusion welding, first, as shown in FIG. 5, the litz wire 412 is inserted in an annular foot part 50 integral with the plug 28. Next, high voltage is applied to the litz wire 412 and the foot part 50 of the plug 28 while pressure is being applied. By this, the heat resistant enamel coat of the copper wire of the litz wire 412 is evaporated, and the litz wire 412 and the plug 28 are welded and are made conductive to each other. By this, the connection between the litz wire 412 and the plug 28 is completed. Incidentally, after the connection between the litz wire 412 and the plug 28 is completed, when necessary, the welded part of the litz wire 412 and the plug 28 is coated with the heat resistant enamel.

The connection between the litz wire 412 and the plug 28 may be performed by caulking. In the case where caulking connection is performed, first, the heat resistant enamel coat of the litz wire is removed by a chemical agent. Next, as shown in FIG. 6, a clamp 39 is covered on the litz wire 412 and the plug 28. Further, as shown in FIG. 7, pressure (F) is applied to the periphery of the clamp 39, so that the litz wire 412 and the plug 28 are caulked and fixed by the clamp 39, and are made conductive to each other.

When high frequency current is applied by the power source 30 through the first and the second plugs 28a and 28b to the electromagnetic induction coil 41, the electromagnetic induction coil 41 generate magnetic flux. By this magnetic flux, eddy-current as induced current is generated in the metal conductive layer 22c of the heat roller 22 so as to prevent the change of the magnetic field. Joule heat is generated by the eddy-current and the resistance of the metal conductive layer 22c, and the heat roller 22 is heated.

The insulating plate 42 is molded by using, for example, PPS resin (Poly Phenylene Sulfide). The insulating plate 42 has a flat plate shape covering the coil center part 414 of the electromagnetic induction coil 41, and is molded to have a thickness of, for example, about 1.0 mm. The insulating plate 42 has a hook part 42a for fixing the insulating plate 42 to the magnetic core 43 at the time of positioning. The material and shape of the insulating plate are not limited, and as long as the electromagnetic induction coil 41 and the magnetic core 43 can be insulated from each other without fail in the coil unit 27, material other than PPS resin may be used, and the mold temperature is also arbitrary. Besides, although the thickness of the insulating plate is also arbitrary, in order to ensure the insulating properties and not to impair the magnetic efficiency of the magnetic core, the range of 0.5 mm to 1.5 mm is more desirable.

The magnetic core 43 concentrates the magnetic flux of the electromagnetic induction coil 41 into the heat roller 22, and improves the magnetic characteristic of the electromagnetic induction coil 41. Thus, the section of the magnetic core 43 is made to have substantially a roof shape having core inclined parts 431 inclined to both sides along the coil center parts 414 of the electromagnetic induction coil 41. A core flat part 432 at the center of the magnetic core 43 has a positioning core protrusion 433 to be supported by the coil holder 40.

The coil holder 40 is made of the same material as the insulating plate 42, and is molded by using PPS resin of a mold temperature of about 280° C. The coil holder 40 includes a thin and long holder main body 401 formed correspondingly to the shape of the coil hole 413 of the electromagnetic induction coil 41, plural holder bosses 402 provided at specified intervals on the holder main body 401, and a holder plate 403 extending downward from the holder main body 401.

The plural holder bosses 402 of the coil holder 40 prevent the electromagnetic induction coil 41 from moving in the longitudinal direction. Further, upper end pawl members 404 of the holder bosses 402 are fitted in the slits 434 provided at the center core flat part 432 of the magnetic core 43 and regulate the position of the magnetic core 43. The holder plate 403 is along the inclination of the coil center part 414 of the electromagnetic induction coil 41. As shown in FIG. 4, the holder plate 403 supports the coil center part 414 of the electromagnetic induction coil 41 from below. Besides, a hook 406 formed at the end of the holder plate 403 supports the outside of the coil center part 414 of the electromagnetic induction coil 41.

The coil holder 40 positions the electromagnetic induction coil 41 and the magnetic core 43, while the insulating plate 42 is sandwiched between the electromagnetic induction coil 41 and the magnetic core 43. The positioning is performed such that the plural holder bosses 402 of the coil holder 40 are inserted in the coil hole 413 of the electromagnetic induction coil 41. Next, the insulating plate 42 is arranged on the coil center part 414 of the electromagnetic induction coil 41. Further, from the above thereof, the holder bosses 402 of the coil holder 40 and the core protrusions 433 of the magnetic core 43 are engaged with each other, and the magnetic core 43 is preliminarily fixed to the coil holder 40. Besides, the pawl members 404 of the coil holder 40 are fitted in the slits 434 of the magnetic core 43. By this, the electromagnetic induction coil 41, the insulating plate 42 and the magnetic core 43 are positioned by the coil holder 40. At this time, the electromagnetic induction coil 41 and the magnetic core 43 are insulated from each other by the insulating plate 42 without fail.

The coil mold 44 is formed such that the electromagnetic induction coil 41, the insulating plate 42 and the magnetic core 43 positioned by the coil holder 40 are set in a die, and liquid insulating mold material (resin material) is injected. In the die, the electromagnetic induction coil 41, the insulating plate 42, the magnetic core 43 and the coil holder 40 are integrally sealed by the mold material except for the first and the second plugs 28a and 28b, and are solidified, so that the coil mold 44 is formed

Incidentally, in the case where the connection between the litz wire 412 and the plug 28 is performed by caulking, the pressure of the flow of the mold material at the time of mold material injection in the die may be used to caulk the clamp 39. In this case, the electromagnetic induction coil 41 in the state where the litz wire 412 whose enamel coating is removed and the plug 28 are covered with the clamp 39, the insulating plate 42 and the magnetic core 43 are set in the die. Next, the mold material is injected in the die, so that the pressing force of the mold material is applied to the periphery of the clamp 39. By this, the clamp 39 is caulked, and at the same time, the electromagnetic induction coil 41, the insulating plate 42, the magnetic core 43 and the coil holder 40 are integrally sealed with the mold material. By doing so, at the time of connection between the litz wire 412 and the plug 28, a step of only caulking the clamp 39 can be omitted.

As the mold material, for example, PPS resin having a mold temperature (solidification temperature) of about 320° C. is used. Incidentally, the mold material is not limited to this, and for example, phenol resin, glass impregnated resin, carbon, ceramic or the like may be used, and it is preferable that the resin is not thermally deformed by heat convection from the heat roller 22 and has heat resistance. The electromagnetic induction coil 41 and the magnetic core 43 are sealed by the solidification of the coil mold 44, and the coil unit 27 is formed in which the first and the second plugs 28a and 28b are exposed.

The center coil unit 27a, and the first and the second side coil units 27b and 27c formed in this way are respectively arranged to be opposite to the heat roller 22. In any of the center coil unit 27a and the first and the second side coil units 27b and 27c, the litz wire is not drawn out to the outside, and when the power source code 36 is removed, the arrangement operation can be performed for the single body of the block-shaped coil unit 27, and the operability is remarkably facilitated.

After the center coil unit 27a and the first and the second side coil units 27b and 27c are arranged, as shown in FIG. 3, the power source code 36 and the connection code 38 are connected to the specified first or the second plug 28a or 28b. By this, the electric power of the power source 30 can be supplied to the center coil unit 27a and the first and the second side coil units 27b and 27c. The connection between the first or the second plug 28a or 28b and the power source code 36 and the connection code 38 can be easily performed by a fitting system in which the first or the second plug 28a or 28b is inserted in the socket 37 of the power source code 36 or the socket 38a of the connection code 38. Besides, also when the power source code 36 and the connection code 38 are detached, this can be easily performed merely by pulling out the socket 37 or 38a from the first or the second plug 28a or 28b.

In the case where for example, either one of the center coil unit 27a and the first and the second side coil units 27b and 27c is exchanged while fixing is performed by the fixing device 11, the socket 37 or the socket 38a is pulled out from the first and the second plugs 28a and 28b of the coil unit 27 to be exchanged, and only the block-shaped coil unit 27 is pulled out, and is exchanged by a new coil unit 27. Thereafter, the new coil unit 27 is connected to the power source 30 by only inserting the first and the second plugs 28a and 28b to the socket 37 or the socket 38a.

According to this embodiment, the first or the second plug 28a or 28b is connected to the starting end 412a and the trailing end 412b of the litz wire of the electromagnetic induction coil 41. In the state where the first and the second plugs 28a and 28b are protruded, the coil mold 44 integrally seals the electromagnetic induction coil 41, the insulating plate 42, the magnetic core 43, and the coil holder 40. The electromagnetic induction coil 41 and the power source 30 can be easily connected by merely inserting the first or the second plug 28a or 28b in the socket 37 of the power source code 36 and the socket 38a of the connection code 38.

By this, it becomes unnecessary to extend the litz wire in the surrounding area of the center coil unit 27a and the first and the second side coil units 27b and 27c arranged to be opposite to the heat roller 22. Accordingly, noise caused by the litz wire extended in the periphery can be eliminated. Besides, it becomes unnecessary to provide a space for extending the litz wire in the surrounding area of the center coil unit 27a and the first and the second side coil units 27b and 27c. Accordingly, it is possible to eliminate uneven temperature of the heat roller 22 caused by the space of a joint portion between the adjacent coil units of the center coil unit 27a and the first and the second side coil units 27b and 27c. Further, the coil unit 27 is substantially block-shaped, in which the first and the second plugs 28a and 28b are merely protruded, and the handling thereof becomes easy. Accordingly, the installation of the coil unit 27 or the operability at the time of exchange can be improved.

Incidentally, the invention is not limited to the above embodiment, but can be variously modified within the scope of the invention. For example, an endless heating member may be a fixing belt, and the shape of the coil and the magnetic core, and the like are also arbitrary. Besides, as long as the positioning of the coil and the magnetic core can be performed, the structure of the positioning holder is not limited. Further, the method of connecting the end of the conductive wire and the conductive terminal, and the method of connecting the conductive terminal and the power source supply unit are also arbitrary, and for example, after the plug and the socket are connected, they may be locked.

What is claimed is:

1. A coil unit of an induction heating fixing device, comprising:
a coil having a conductive wire to generate an induced current in a conductive heat generating member;
a magnetic core insulated from the coil and provided to be adjacent to the coil;
a positioning holder to position the coil and the magnetic core;
a conductive terminal connected to an end of the conductive wire; and
a fixing body to expose the conductive terminal and to integrate the coil and the magnetic core supported by the positioning holder.

2. The coil unit of the induction heating fixing device according to claim 1, wherein the conductive terminal is exposed at each of both sides of the fixing body in a longitudinal direction.

3. The coil unit of the induction heating fixing device according to claim 1, wherein the conductive terminal is exposed at one side of the fixing body in a longitudinal direction.

4. The coil unit of the induction heating fixing device according to claim 1, wherein the conductive terminal can be attached to and detached from a power supply unit for the coil.

5. The coil unit of the induction heating fixing device according to claim 4, wherein the conductive terminal is plugged in the power source supply unit for the coil.

6. The coil unit of the induction heating fixing device according to claim 1, wherein the conductive terminal is connected to the end of the conductive wire by fusion welding.

7. The coil unit of the induction heating fixing device according to claim 1, wherein the conductive terminal and the end of the conductive wire are bundled by a clamp member and are connected to each other.

8. The coil unit of the induction heating fixing device according to claim 7, wherein the fixing body is solidified after being molded in liquid form, and the clamp member is bundled by pressing force of the liquid fixing body.

9. An induction heating fixing device comprising:
a heating member having an endless conductive heat generating member;
at least one coil unit including a coil that is arranged an outer circumference of the heating member, has a conductive wire to generate an induced current in the conductive heat generating member, a magnetic core that is insulated from the coil and is provided to be adjacent to the coil, a positioning holder that positions the coil and the magnetic core, a conductive terminal that is connected to an end of the conductive wire, and a fixing body that exposes the conductive terminal and integrates the coil and the magnetic core supported by the positioning holder; and
a carrying member that nips and conveys a medium to be fixed in a specified direction in cooperation with the heating member.

10. The induction heating fixing device according to claim 9, wherein the conductive terminal is exposed at each of both sides of the fixing body in a longitudinal direction.

11. The induction heating fixing device according to claim 9, wherein the conductive terminal is exposed at one side of the fixing body in a longitudinal direction.

12. The induction heating fixing device according to claim 9, wherein the conductive terminal is exposed on a side opposite to a surface of the fixing body facing the heating member.

13. The induction heating fixing device according to claim 9, wherein the conductive terminal can be attached to and detached from a power supply unit for the coil.

14. The induction heating fixing device according to claim 9, wherein the conductive terminal is connected to the end of the conductive wire by fusion welding.

15. The induction heating fixing device according to claim 9, wherein the conductive terminal and the end of the conductive wire are bundled by a clamp member and are connected to each other.

16. The induction heating fixing device according to claim 15, wherein the fixing body is solidified after being molded in liquid form, and the clamp member is bundled by pressing force of the liquid fixing body.

17. The induction heating fixing device according to claim 9, wherein a plurality of the coil units are arranged in a rotation axis direction of the heating member, and generate induced current in different areas of the conductive heat generating member.

18. An installation method of a coil unit, comprising:
arranging at least one coil unit near an outer circumference of a heating member; and
electrically connecting a conductive terminal of the coil unit to a power source supply unit.

19. The installation method of the coil unit according to claim 18, further comprising:
releasing electrical connection between the conductive terminal and the power source supply unit, and exchanging the coil unit.

20. The installation method of the coil unit according to claim 18, wherein the conductive terminal is plugged in the power source supply unit and is electrically connected to each other.
